(19) United States
(12) Patent Application Publication
(10) Pub. No.: US 2023/0121386 A1
(43) Pub. Date: Apr. 20, 2023

(54) Trailer Tandem Pin Device

(71) Applicant: Betty Barnett, Magnolia, AR (US)

(72) Inventor: Betty Barnett, Magnolia, AR (US)

(21) Appl. No.: 17/935,751

(22) Filed: Sep. 27, 2022

Related U.S. Application Data
(60) Provisional application No. 63/256,778, filed on Oct. 18, 2021.

(51) Int. Cl. B62D 53/10; B62D 63/08

(52) U.S. Cl. CPC B62D 53/10; B62D 63/08

(57) ABSTRACT

The present invention relates to a trailer tandem pin device primarily comprised of at least one vertical member that is fixedly or removably attached to at least one horizontal member. The horizontal member is attached perpendicular to the vertical member, wherein the horizontal member has at least one notch that engages the inner surface of a rail hole of a trailer tandem. The notch prevents the device from falling out of the rail hole, thereby securing the tandem.

### CROSS-REFERENCE TO RELATED APPLICATION

The present application claims priority to, and the benefit of, U.S. Provisional Application No. 63/256,778, which was filed on Oct. 18, 2021, and is incorporated herein by reference in its entirety.

### FIELD OF THE INVENTION

The present invention relates generally to the field of semi-trailer retention devices. More specifically, the present invention relates to a trailer tandem pin device primarily comprised of at least one vertical member that is fixedly or removably attached to at least one horizontal member. The horizontal member is attached perpendicular to the vertical member, wherein the horizontal member has at least one notch that engages the inner surface of a rail hole of a trailer tandem. The notch prevents the device from falling out of the rail hole, thereby securing the tandem. Accordingly, the present disclosure makes specific reference thereto. Nonetheless, it is to be appreciated that aspects of the present invention are also equally applicable to other like applications, devices, and methods of manufacture.

### BACKGROUND

Semi-truck drivers may have to constantly get in and out of their truck to adjust the tandem on a trailer during a trip. To do so, drivers may have to adjust the tandem while on the side of the road, putting themselves in severe danger of being struck by another motorist. Further, making tandem adjustments numerous times per trip can be exceptionally frustrating and inefficient for any semi-truck driver.

Therefore, there exists a long-felt need in the art for a novel trailer tandem device. There also exists a long-felt need in the art for a trailer tandem pin device that can be universally used with any trailer tandem. Further, there exists a long-felt need in the art for a trailer tandem pin device that can be inserted into a trailer tandem to prevent a semi-truck driver from having to reposition the tandem numerous times during a trip.

The subject matter disclosed and claimed herein, in one embodiment thereof, comprises a trailer tandem pin device. The device is primarily comprised of at least one vertical member that is fixedly or removably attached to at least one horizontal member. The device may also be comprised of at least one pin, at least one strap, and/or at least one clip. The horizontal member is attached perpendicular to the vertical member, wherein the horizontal member has at least one notch that engages the inner surface of a rail hole of a trailer tandem. The notch prevents the device from falling out of the rail hole, thereby securing the tandem. The device may be further secured to the rail hole and/or tandem via the pin positioned on one or both sides of the notch and the strap which is attached to the vertical member and can clip to/around the rail hole via the clip.

In this manner, the trailer tandem pin device of the present invention accomplishes all of the foregoing objectives and provides a novel trailer tandem device that can be universally used with any trailer tandem. Further, the device prevents a semi-truck driver from having to reposition the tandem numerous times during a trip.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trailer tandem pin device. The device is primarily comprised of at least one vertical member that is fixedly or removably attached to at least one horizontal member. The device may also be comprised of at least one pin, at least one strap, and/or at least one clip. The vertical member and horizontal member are preferably tubular, wherein the horizontal member is preferably positioned perpendicular to the vertical member.

In one embodiment, the vertical member and horizontal member are fixedly attached to one another via a weld, or any other permanent fastening method known in the art. In a differing embodiment, the horizontal member and vertical member are removably attached to each other such that the device can be disassembled for easy storage. In a removable embodiment, the vertical member may be comprised of at least one fastener. The horizontal member may also be comprised of at least one reciprocating fastener that engages the fastener of the vertical member.

The horizontal member is further comprised of at least one notch that may be positioned anywhere on the horizontal member but is preferably positioned in the middle of the horizontal member. The notch contacts the inner surface of a rail hole of a tandem of a semi-truck/trailer. As a result, the device remains in place within the rail hole while the semi-truck/trailer is in motion such that a driver need not exit their truck to re-adjust a trailer tandem using the rail hole during their trip.

In one embodiment, the horizontal member is comprised of at least one opening that receives at least one pin wherein the pin prevents the horizontal member from sliding out of the rail hole. In another embodiment, the horizontal member has two openings, one opening on each side of the notch, which further prevents the horizontal member from sliding out of the rail hole.

The vertical member may also be comprised of at least one strap. The strap may be fixedly attached to the vertical member or removably attached to the vertical member via being looped through at least one opening in the first end of the vertical member. The strap is preferably comprised of at least one fastener that allows the strap to lengthen and shorten in length. At least one clip is preferably fixedly or removably attached to the strap such that the strap can be clipped through, to, or around the rail hole. Therefore, the entire device is retained on the semi-truck/semi-trailer if the horizontal member falls out of the rail hole.

Accordingly, the trailer tandem pin device of the present invention is particularly advantageous as it provides a novel trailer tandem device that can be universally used with any trailer tandem. Further, the device prevents a semi-truck driver from having to reposition the tandem numerous times during a trip. In this manner, the trailer tandem pin device overcomes the limitations of existing methods of using trailer tandems known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a trailer tandem pin device of the present invention in accordance with the disclosed architecture;

FIG. 2 illustrates a perspective view of one potential embodiment of a trailer tandem pin device of the present invention while attached to a semi-trailer through a rail hole in accordance with the disclosed architecture; and

FIG. 3 illustrates a perspective view of one potential embodiment of a trailer tandem pin device of the present invention with a strap while attached to a semi-trailer through a rail hole in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a novel trailer tandem device. There also exists a long-felt need in the art for a trailer tandem pin device that can be universally used with any trailer tandem. Further, there exists a long-felt need in the art for a trailer tandem pin device that can be inserted into a trailer tandem to prevent a semi-truck driver from having to reposition the tandem numerous times during a trip.

The present invention, in one exemplary embodiment, is comprised of a trailer tandem pin device primarily comprised of at least one vertical member that is fixedly or removably attached to at least one horizontal member. The device may also be comprised of at least one pin, at least one strap, and/or at least one clip. The vertical member and horizontal member are preferably tubular, wherein the horizontal member is preferably positioned perpendicular to the vertical member.

The vertical member and horizontal member may be fixedly attached to one another via a weld, or any other permanent fastening method known in the art. In a differing embodiment, the horizontal member and vertical member are removably attached to each other such that the device can be disassembled for easy storage. In a removable embodiment, the vertical member may be comprised of at least one fastener and wherein the horizontal member may also be comprised of at least one reciprocating fastener that engages the fastener of the vertical member.

The horizontal member is further comprised of at least one notch that may be positioned anywhere on the horizontal member but is preferably positioned in the middle of the horizontal member. The notch contacts the inner surface of a rail hole of a tandem of a semi-truck/trailer. As a result, the device remains in place within the rail hole while the semi-truck/trailer is in motion such that a driver need not exit their truck to re-adjust a trailer tandem using the rail hole during their trip.

The horizontal member may be comprised of at least one opening that receives at least one pin wherein the pin prevents the horizontal member from sliding out of the rail hole. In another embodiment, the horizontal member has two openings, one opening on each side of the notch, which further prevents the horizontal member from sliding out of the rail hole.

The vertical member may also be comprised of at least one strap fixedly attached to the vertical member or removably attached to the vertical member via being looped through at least one opening in the first end of the vertical member. The strap is preferably comprised of at least one fastener that allows the strap to lengthen and shorten in length. At least one clip is preferably fixedly or removably attached to the strap such that the strap can be clipped through, to, or around the rail hole. Therefore, the entire device is retained on the semi-truck/semi-trailer if the horizontal member falls out of the rail hole.

Accordingly, the trailer tandem pin device of the present invention is particularly advantageous as it provides a novel trailer tandem device that can be universally used with any trailer tandem. Further, the device prevents a semi-truck driver from having to reposition the tandem numerous times during a trip. In this manner, the trailer tandem pin device overcomes the limitations of existing methods of using trailer tandems known in the art.

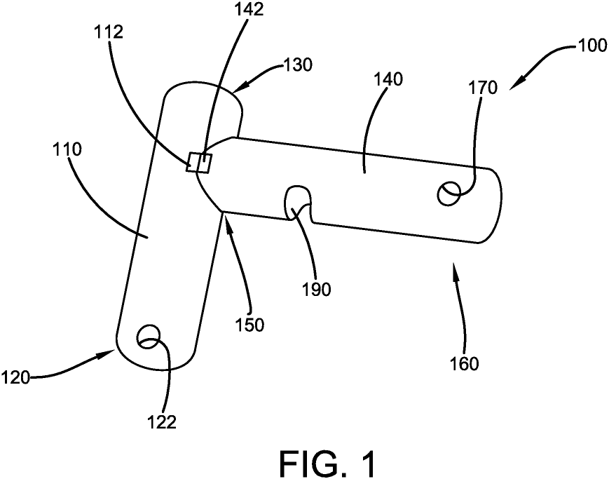

Referring initially to the drawings, FIG. 1 illustrates a perspective view of one potential embodiment of a trailer tandem pin device 100 of the present invention in accordance with the disclosed architecture. The device 100 is primarily comprised of at least one vertical member 110 that is fixedly or removably attached to at least one horizontal member 140. The device 100 may also be comprised of at least one pin 180, at least one strap 200, and/or at least one clip 220. Unless otherwise specified herein, the device 100 and all components are preferably manufactured from a metal material such as, but not limited to, stainless steel or aluminum.

The vertical member 110 and horizontal member 140 are preferably tubular, but may be square, rectangular, or any other shape or style in a differing embodiment. The horizontal member 140 is preferably positioned perpendicular to the vertical member 110. However, in differing embodiments, the angle formed between the horizontal member 140 and vertical member 110 may be any angle less than 180 degrees.

In one embodiment, the members 110,140 are fixedly attached to one another via a weld or any other permanent fastening method known in the art. In a differing embodiment, the horizontal member 140 and vertical member 110 are removably attached to each other such that the device 100 can be disassembled for easy storage. In either attachment method, the second end 130 of the vertical member 110 preferably attaches to the first end 150 of the horizontal member 140. In this embodiment, the vertical member 110 may be comprised of at least one fastener 112, and the horizontal member 140 may be comprised of at least one reciprocating fastener 142 that engages the fastener 112 of the vertical member 110. The fasteners 112,142 may be any fastener or fastening means known in the art such as, but not limited to, a bolt, a nut, a tongue fastener, a groove fastener, etc.

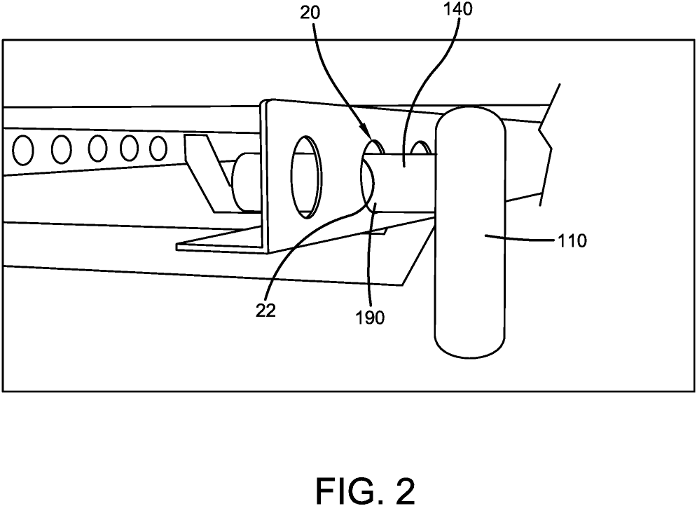

FIG. 2 illustrates a perspective view of one potential embodiment of a trailer tandem pin device 100 of the present invention while attached to a semi-trailer through a rail hole 20 in accordance with the disclosed architecture. The horizontal member 140 is further comprised of at least one notch 190. The notch 190 may be positioned anywhere on the horizontal member 140 but is preferably positioned in the middle of the horizontal member 140. The notch 190 contacts the inner surface 22 of a rail hole 20 of a tandem of a semi-truck/trailer. In this manner, the device 100 remains in place within the rail hole 20 while the semi-truck/trailer is in motion such that a driver need not exit their truck to re-adjust a trailer tandem using the rail hole 20 during their trip.

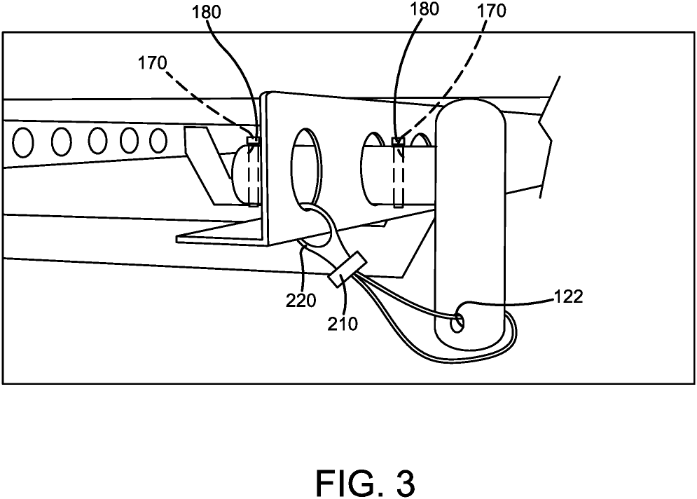

In one embodiment, the horizontal member 140 is comprised of at least one opening 170 that receives at least one pin 180, as seen in FIG. 3. In one embodiment, the opening 170 and pin 180 are positioned near the second end 160 of the horizontal member 140 such that the pin 180 prevents the horizontal member 140 from sliding out of the rail hole 20. In another embodiment, the horizontal member has two openings 170; one opening 170 on each side of the notch 190. This further prevents the horizontal member 140 from sliding out of the rail hole 20. The pin 180 may be any pin type known in the art such as, but not limited to, a dowel pin, a spring pin, a taper pin, a headed pin, a quick-release pin, a hitch pin, a locking pin, a locating pin, an alignment pin, a cotter pin, a clevis pin, a detent ball pin, a tee head pin, a humped pin, a self-locking pin, a hammerlock pin, etc. In this manner, the horizontal member 140 is further secured within the rail hole 20.

The vertical member 110 may also be comprised of at least one strap 200. The strap 200 may be any fabric, rope, or braided metal material. The strap 200 may be fixedly attached to the vertical member 110 or removably attached to the vertical member 110 via being looped through at least one opening 122 in the first end 120 of the vertical member 110. The strap 200 is preferably comprised of at least one fastener 210 such as, but not limited to, a buckle, a pin, a ratcheting mechanism, etc., that allows the strap 200 to lengthen and shorten in length. At least one clip 220 such as, but not limited to, a locking carabiner or locking clip is preferably fixedly or removably attached to the strap 200 such that the strap 200 can be clipped through, to, or around the rail hole 200. In this manner, the entire device 100 is retained on the semi-truck/semi-trailer if the horizontal member 140 falls out of the rail hole 20.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trailer tandem pin device” and “device” are interchangeable and refer to the trailer tandem pin device 100 of the present invention.

Notwithstanding the foregoing, the trailer tandem pin device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the trailer tandem pin device 100 as shown in the FIGS. are for illustrative purposes only, and that many other sizes and shapes of the trailer tandem pin device 100 are well within the scope of the present disclosure. Although the dimensions of the trailer tandem pin device 100 are important design parameters for user convenience, the trailer tandem pin device 100 may be of any size, shape and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trailer tandem pin device comprising:
a horizontal member comprised of a notch; and
a vertical member attached to the horizontal member.

2. The trailer tandem pin device of claim 1, wherein the horizontal member is fixedly attached to the vertical member.

3. The trailer tandem pin device of claim 1, wherein the notch is positioned in a middle of the horizontal member.

4. A trailer tandem pin device comprising:
a horizontal member comprised of a notch;
a vertical member attached to the horizontal member;
a strap; and
a clip.

5. The trailer tandem pin device of claim 4, wherein the strap is comprised of a fastener.

6. The trailer tandem pin device of claim 5, wherein the fastener is a buckle, a pin or a ratcheting mechanism.

7. The trailer tandem pin device of claim 4, wherein the fastener allows the strap to lengthen or shorten in length.

8. The trailer tandem pin device of claim 4, wherein the clip is a locking carabiner.

9. The trailer tandem pin device of claim 4, wherein the strap is comprised of a fabric, a rope or a braided metal material.

10. The trailer tandem pin device of claim 4, wherein the strap is fixedly attached to the vertical member.

11. A trailer tandem pin device comprising:
a horizontal member comprised of a notch and a first opening;
a vertical member attached to the horizontal member, wherein the vertical member is comprised of a second opening; and
a strap; and
a clip.

12. The trailer tandem pin device of claim 11 further comprised of a pin.

13. The trailer tandem pin device of claim 12, wherein the pin is a dowel pin, a spring pin, a taper pin, a headed pin, a quick-release pin, a hitch pin, a locking pin, a locating pin, an alignment pin, a cotter pin, a clevis pin, a detent ball pin, a tee head pin, a humped pin, a self-locking pin or a hammerlock pin.

14. The trailer tandem pin device of claim 11, wherein the first opening is positioned on a first side of the notch.

15. The trailer tandem pin device of claim 11, wherein the strap attaches to the vertical member through the opening.

16. The trailer tandem pin device of claim 11, wherein the horizontal member attaches to the vertical member and is perpendicular thereto.

17. The trailer tandem pin device of claim 11, wherein the horizontal member further comprises a fastener.

18. The trailer tandem pin device of claim 17, wherein the fastener is a bolt, a nut, a tongue fastener or a groove fastener.

19. The trailer tandem pin device of claim 11, wherein the vertical member is further comprised of a fastener.

20. The trailer tandem pin device of claim 19, wherein the fastener is a bolt, a nut, a tongue fastener or a groove fastener.
